(19) United States
(12) Patent Application Publication
(10) Pub. No.: US 2001/0048278 A1
(43) Pub. Date: Dec. 6, 2001

(54) CROSS COUPLED MOTOR GATE DRIVE

(76) Inventors: GLEN C. YOUNG, FORT WAYNE, IN (US); JAMES R. KIEFER, FORT WAYNE, IN (US)

Correspondence Address: DAMIAN WASSERBAUER, ESQ., COUNSEL, INTELLECTUAL PROPERTY, GENERAL ELECTRIC COMPANY, 41 WOODFORD AVENUE, PLAINVILLE, CT, 06062, US

(21) Appl. No.: 09/243,938

(22) Filed: Feb. 4, 1999

(51) Int. Cl. H02P 1/18

(52) U.S. Cl. 318/254

(57) ABSTRACT

A motor system including a gate drive for driving a motor. An inverter bridge circuit selectively connects power supply link rails to a winding of the motor for energizing the winding with a motoring current. The bridge circuit has upper and lower power switches connected between the winding and the upper and lower power supply link rails, respectively. Each lower switch corresponds to one of the upper switches on the same side of the winding as the lower switch to define an arm of the bridge circuit. A control circuit generates a motor control signal to control the switches. A drive circuit drives the upper switches in response to the state of the corresponding lower switches, which are responsive to the motor control signal. The drive circuit includes a voltage gain element connected to each arm of the bridge circuit that is responsive to current in the respective lower switch for maintaining the corresponding upper switch in its nonconducting state. In a three phase embodiment, a quadrature axis winding corresponds to each phase winding. Each of the quadrature axis windings is in magnetic coupling relation with the rotatable assembly and positioned for generating an output signal representative of angular position of the rotatable assembly. The control circuit generates the motor control signal to control commutation of the phase windings in response to the output signals of the quadrature axis windings.

### BACKGROUND OF THE INVENTION

This invention relates generally to motor systems and, particularly, to an improved gate drive for a single or multi-phase electronically controlled motor.

An electronically commutated motor (ECM) of the type described herein has a stator with a plurality of teeth and a rotor with permanent magnets mounted on it. When wire-wound coils on the teeth are energized with current, the stator and rotor interact to produce positive or negative torque, depending on the direction of the current with respect to the polarity of the magnets. In motors of this type, an electronic inverter bridge controls energization of the stator winding for controlling the direction and amount of torque produced by the motor as well as for controlling the rotor shaft speed. The inverter bridge typically has a number of power switching devices for connecting the motor's winding or windings to a power supply. Often, the devices are arranged with respect to upper and lower rails of a power supply link and have a fly back diode coupled to each of the devices.

Commonly assigned application Ser. No. 08/865,135, the entire disclosure of which is incorporated herein by reference, shows an improved single phase motor gate drive that controls the upper power switches of the motor's inverter bridge in response to the states of the lower power switches. This gate drive eliminates the use of high voltage gate level shifters for driving the inverter bridge and reduces shoot-through currents. As is known in the art, commutation of the motor is usually controlled as a function of the angular position of the motor's rotor. Commonly assigned U.S. Pat. No. 5,796,194 and application Ser. No. 09/048,946, the entire disclosures of which are incorporated herein by reference, show an improved means for sensing rotor position in a single phase motor with a quadrature axis winding.

Although these inventions provide improvements, further improvements including reducing the cost of the motor are still desired. In particular, the gate drive circuit of application Ser. No. 08/865,135 employs a power diode that responds to the turn on of the lower power switch and forces off the gate drive of the upper switch. The diode then provides conduction of load current from the winding while clamping the upper gate to an acceptable voltage. This diode, however, also blocks the flow of fly back current. The unimpeded flow of fly back current through the internal fly back diodes of the lower power switches is desired for complete operation. Thus, a cross coupled gate drive improved in this regard is desired. In addition, a gate drive is desired for use at higher power levels and for use with a multi-phase motor.

With respect to driving a three phase motor, conventional techniques for detecting the angular position of the motor's rotor, such as sensing the back electromotive force (EMF) in the windings, may not be available. Further, conventional current regulation and conduction schemes may result in undesirable amounts of torque ripple and noise. Therefore, additional improvements in controlling three phase gate drives are also desired including quadrature axis position sensing and current regulation based on quadrature axis voltages.

U.S. Pat. Nos. 5,552,685, 5,423,192, 4,933,584, 4,757,603 and 4,757,241, all of which are commonly assigned with the present application and the entire disclosures of which are incorporated herein by reference, disclose electronically controlled motors.

### SUMMARY OF THE INVENTION

The invention meets the above needs and overcomes the deficiencies of the prior art by providing an improved system including a cross coupled gate drive for driving a motor.

Briefly described, a motor system embodying aspects of the invention has a stationary assembly including at least one winding and a rotatable assembly in magnetic coupling relation to the stationary assembly. The system also includes a power supply link having upper and lower rails supplied by a power supply. A bridge circuit selectively connects the rails to the winding for energizing it with a motoring current to produce an electromagnetic field for rotating the rotatable assembly relative to the stationary assembly. The bridge circuit has upper and lower power switches connected between the winding and the upper and lower rails, respectively. Each lower switch corresponds to one of the upper switches on the same side of the winding as the lower switch to define an arm of the bridge circuit. The system further includes a control circuit for generating a motor control signal to control the switches. A drive circuit drives the upper switches in response to the state of the corresponding lower switches, which are responsive to the motor control signal. The drive circuit includes a voltage gain element connected to each arm of the bridge circuit that is responsive to current in the respective lower switch for maintaining the corresponding upper switch on the same arm of the bridge circuit in its nonconducting state.

Generally, another form of the invention is directed to an inverter bridge for driving a motor. The motor has a stationary assembly including at least one winding and a rotatable assembly in magnetic coupling relation to the stationary assembly. The motor also includes a power supply link having upper and lower rails supplied by a power supply and a control circuit for generating a motor control signal to control commutation of the winding. The inverter bridge has upper and lower power switches connected between the winding and the upper and lower rails, respectively. Each lower switch corresponds to one of the upper switches on the same side of the winding as the lower switch. The inverter bridge also includes a drive circuit for driving the upper switches in response to the state of the corresponding lower switches, which are responsive to the motor control signal. The drive circuit has a voltage gain element connected to each of the lower switches that is responsive to current in the respective lower switch for maintaining the corresponding upper switch in its nonconducting state. In this manner, the inverter bridge selectively connects the rails to the winding for energizing it with a motoring current to produce an electromagnetic field for rotating the rotatable assembly relative to the stationary assembly.

In yet another embodiment of the invention, a three phase motor system has a stationary assembly including three phase windings and a rotatable assembly in magnetic coupling relation to the stationary assembly. A quadrature axis winding corresponds to each phase winding. Each of the quadrature axis windings is in magnetic coupling relation with the rotatable assembly and positioned for generating an output signal representative of angular position of the rotatable assembly. The system further includes a control circuit for generating a motor control signal to control commutation of the phase windings in response to the output signals of the quadrature axis windings.

Alternatively, the invention may comprise various other methods and systems.

Other objects and features will be in part apparent and in part pointed out hereinafter.

### BRIEF DESCRIPTION OF THE DRAWINGS

FIG. 1 is a block diagram of a motor system according to a preferred embodiment of the invention.

FIG. 2 illustrates an inverter bridge embodying a preferred cross coupled gate drive for driving the motor of FIG. 1.

FIG. 3 illustrates an inverter bridge embodying another preferred cross coupled gate drive for driving the motor of FIG. 1.

FIGS. 4A-4C graphically illustrate exemplary operation of the motor of FIG. 1 with respect to speed according to a three phase electronically commutated motor control based on instant regulation of peak current in the negative rail of the inverter bridge.

FIGS. 5A and 5B graphically illustrate exemplary phase currents and voltages with respect to electrical degrees of rotation for the motor operation of FIGS. 4A-4C.

FIG. 6 graphically illustrates two exemplary sequences of phase voltage applied to the motor of FIG. 1 for operating a three phase electronically commutated motor.

FIGS. 7A-7C graphically illustrate exemplary operation of the motor of FIG. 1 with respect to speed according to a three phase electronically commutated motor control based on sine wave voltage regulation of the phase leg pulse width modulation values in response to the observed current in the negative rail of the inverter bridge.

FIGS. 8A-8C graphically illustrate exemplary operation of the motor of FIG. 1 with respect to speed according to a three phase electronically commutated motor control based on trapezoidal voltage regulation of the phase leg pulse width modulation values in response to the observed current in the negative rail of the inverter bridge.

FIGS. 9A-9C graphically illustrate exemplary voltages, currents and phase leg duty cycle of the motor of FIG. 1 during trapezoidal operation.

FIG. 10 is a flattened side view of the stator of FIG. 1 including quadrature axis windings extending through a plurality of stator notches.

FIGS. 11A-11C graphically illustrate exemplary voltages, currents and phase leg duty cycles of the motor of FIG. 1 using the quadrature axis windings of FIG. 10 for rotor position tracking.

FIGS. 12A-12D graphically illustrate exemplary start-up operation of the motor of FIG. 1 operating in accordance with the quadrature axis rotor position tracking of FIGS. 11A-11C.

Corresponding reference characters indicate corresponding parts throughout the drawings.

### DETAILED DESCRIPTION OF PREFERRED EMBODIMENTS

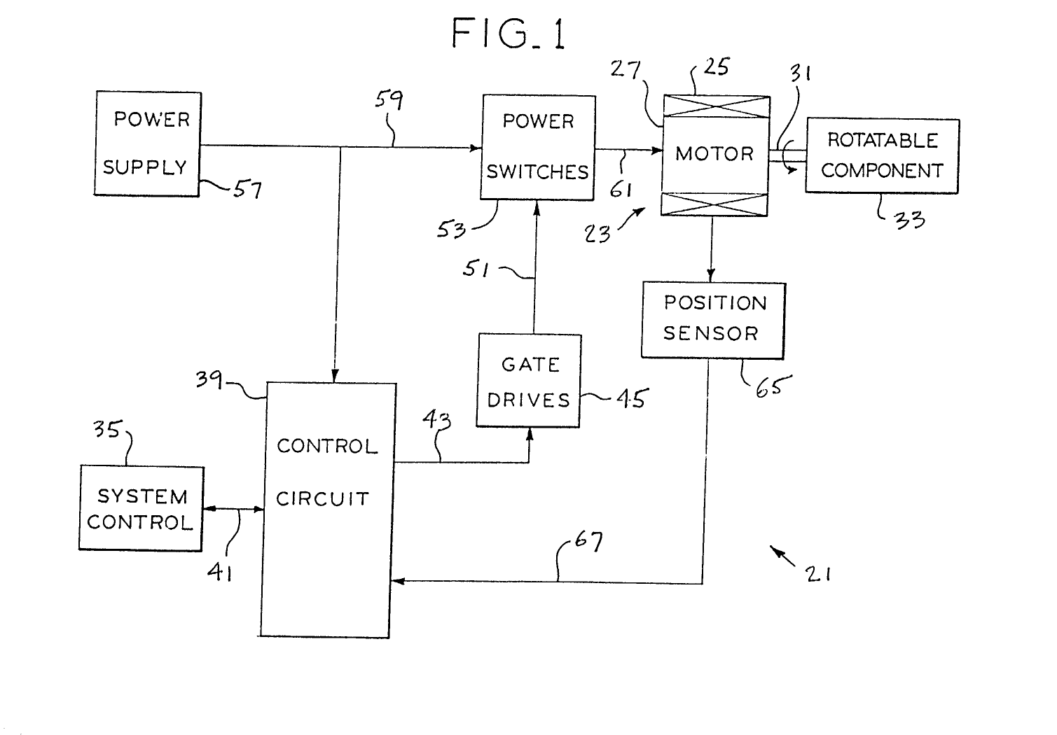

Referring now to the drawings, FIG. 1 shows a motor system 21 according to a preferred embodiment of the present invention. The system 21 includes a motor, generally designated 23, having a stationary assembly, or stator, 25 and a rotatable assembly, or rotor, 27 in magnetic coupling relation to the stator 25. In the embodiment described herein, motor 23 is an electronically commutated motor. It is to be understood, however, that aspects of the present invention may be applied to any electronically controllable motor or dynamoelectric machine typically powered by an electronic control circuit. Such motors include, for example, external rotor motors (i.e., inside out motors), permanent magnet motors, single and variable speed motors, selectable speed motors having a plurality of speeds, brushless DC motors, electronically commutated motors, switched reluctance motors and induction motors. In addition, the motors may be multi-phase or single phase motors and, in any case, such motors may have a single split phase winding or a multi-phase winding. Such motors may also provide one or more finite, discrete rotor speeds selected by an electrical switch or other control circuit.

In a preferred embodiment of the invention, a motor shaft 31 mechanically connects the rotor 27 to a particular device to be driven, such as a rotatable component 33. For example, the rotatable component 33 comprises a fan, blower, compressor or the like for use in a heating, ventilating and air conditioning system or refrigeration system. Although motor 23 is particularly useful for driving a fan, it is to be understood that motor 23 may be part of a number of different systems for driving other rotatable components. In addition, rotatable component 33 may include a connection mechanism for coupling it to the shaft 31.

Preferably, a user interface, or system control, 35 provides system control signals to a control circuit 39 via line 41. In this instance, the system control signals take the form of motor commands representing, for example, turn on and turn off commands, desired fan speeds and the like. In response to the system control signals, the control circuit 39 then generates motor control signals. As represented by the block diagram of FIG. 1, control circuit 39 provides the motor control signals via line 43 for electronically controlling a plurality of gate drives 45. In turn, the gate drives 45 provide drive signals via line 51 for switching a plurality of power switches 53, such as insulated gate bipolar transistors, bipolar junction transistors or metal oxide silicon field effect transistors. In addition to providing sufficient voltage (e.g., 15 volts) for driving the power switches 53, gate drives 45 also condition the signals provided by control circuit 39 for optimal operation of power switches 53. In a preferred embodiment of the invention, control circuit 39 is embodied by a microprocessor, microcontroller and/or an application specific integrated circuit (ASIC). A digital signal processor (DSP) may also be used to implement some or all of the functions of control circuit 39.

A power supply 57 provides high voltage DC power to switches 53 via line 59.

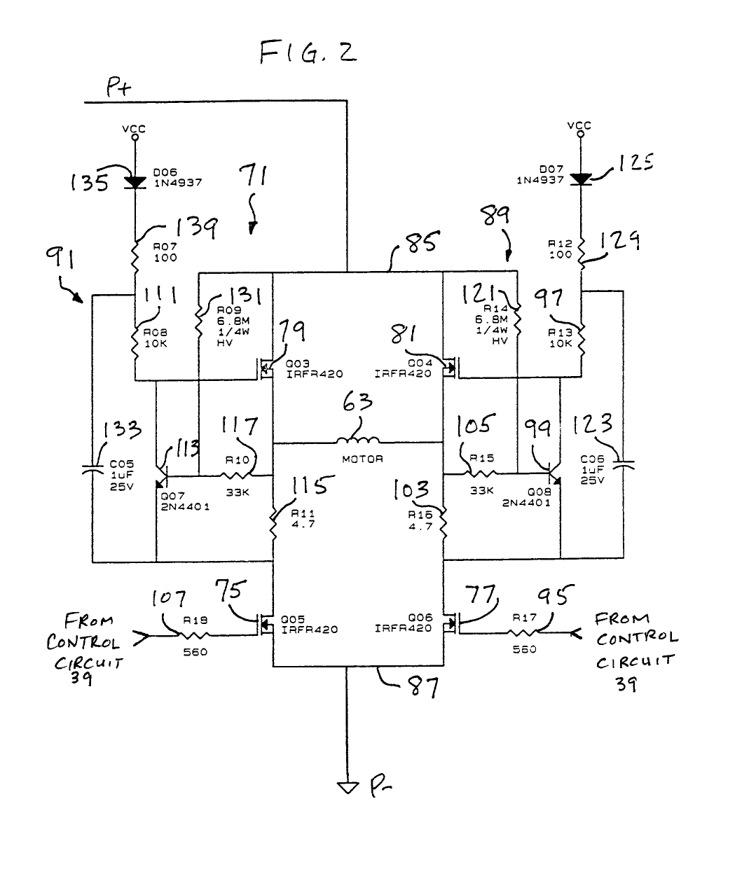

Power switches 53 then provide power to motor 23 via line 61 by selectively switching the power supply 57 in connection with a motor winding(s) 63 (see FIG. 2) included in stator 25.

Preferably, power switches 53 energize the motor winding 63 in at least one preselected sequence for commutating motor 23 in response to control circuit 39. In this instance, control circuit 39 selectively activates power switches 53 to control rotation in motor 23 as a function of the motor control signals. It is to be understood that power supply 57 may also provide power to operate control circuit 39.

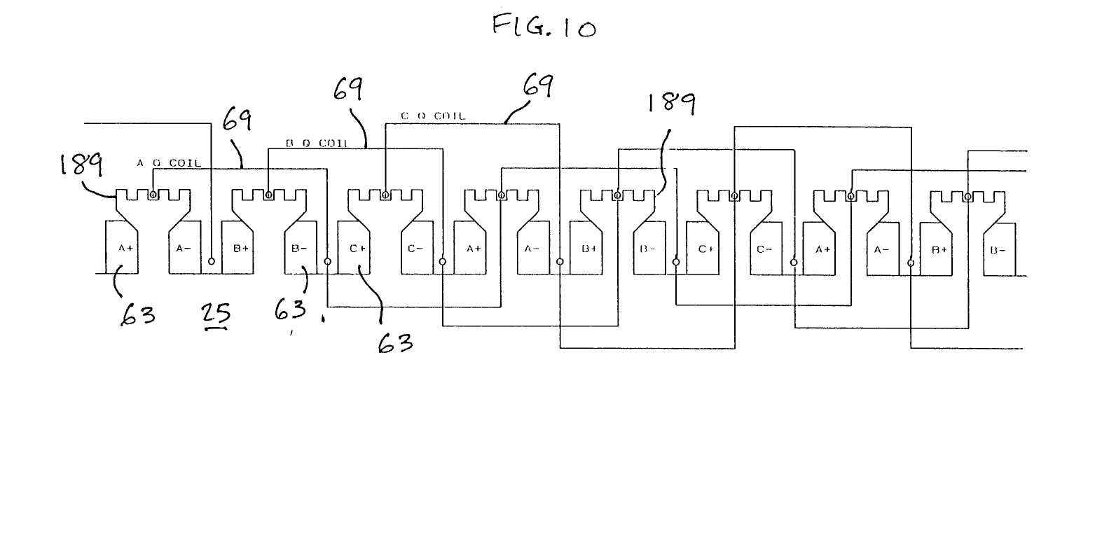

Referring further to FIG. 1, a position sensor 65 provides control circuit 39 with a feedback signal via line 67 that is representative of the angular position of rotor 27 relative to stator 25. For example, a quadrature winding(s) 69 (see FIG. 10) embodies the position sensor 65. In general, the position signal has a predefined angular relationship relative to the motor back EMF (e.g., in phase or up to 90° out of phase with the back EMF of motor 23), which permits an estimation of rotor position. In a three phase motor, for example, control circuit 39 may observe the motor phase quadrature waveforms in the windings for position sensing. Other position sensors, such as one or more Hall sensors or optical sensors, may also be used to provide rotor position feedback instead of or in addition to the quadrature winding 69 or back EMF information.

The control circuit 39 preferably generates its control signals as a function of the estimated zero crossings of the back EMF of winding 63. Since the product of the current and the back EMF determines torque production in motor 23, control circuit 39 sustains positive torque by energizing winding 63 when the back EMF has crossed zero in the direction that will oppose the voltage energizing them. It is desired that motor current crosses zero at the time the motor back EMF also crosses zero, so control circuit 39 preferably commutates motor 23 at an angle relative to the next back EMF zero crossing. In other words, control circuit 39 estimates subsequent back EMF zero crossings based on the sensed position of rotor 27 and generates gate drive signals at line 51 for driving power switches 53 coincident with or in advance of the estimated back EMF zero crossings. Thus, control circuit 39 generates the motor control signals as a function of the sensed position of rotor 27 as represented by the position signal. Commonly assigned U.S. Pat. No. 5,423,192 describes one preferred means for detecting zero crossings.

In operation, control circuit 39 implements a state machine for generating signals that define desired commutation intervals based on the system control signals. In response to the motor control, or commutation, signals generated by control circuit 39, gate drives 45 cause power switches 53 to switch. The resulting motor current preferably matches the load torque demand as a function of a regulated current reference level. By matching torque load with produced torque, motor 23 is able to operate at a desired torque or speed. In one embodiment, the motor control signals include a series of pulse width modulated cycles, wherein each cycle causes a corresponding switching event of power switches 53. The current in winding 63 produces an electromagnetic field for rotating the rotor 27 of motor 23. To control the speed of rotatable component 33, system 21 preferably controls the power delivered to the load to control the speed of motor 23. In particular, system 21 regulates current in motor 23, which in turn regulates torque, to obtain the desired motor speed by matching the load and motor loss demand torque at the desired speed.

As an example of a current regulation scheme, control circuit 39 defines alternating on and off intervals based on instantaneous current levels in winding 63. When the measured current reaches a predetermined peak level, control circuit 39 commands power switches 53 to turn the current off for an interval of time determined by, for example, an asynchronous oscillator or an off timer. In the alternative, control circuit 39 performs voltage regulation using a variable duty cycle signal. The duty cycle may vary from, for example, 0% to 100% where 100% corresponds to a maximum voltage.

FIG. 2 illustrates a preferred cross coupled gate drive scheme for driving motor 23 according to the present invention. As shown in FIG. 2, an inverter bridge circuit 71 has two lower switches 75, 77 (Q05, Q06) and two upper switches 79, 81 (Q03, Q04) embodying power switches 53. A fly back diode (not shown in FIG. 2) is coupled in an anti-parallel relationship with each switch 75, 77, 79, 81. In this instance, FIG. 2 illustrates switches 75, 77, 79, 81 as field effect transistors in which the fly back diodes are internal to the components. As connected to motor winding 63, the inverter bridge circuit 71 forms an H-bridge configuration for use in driving motor 23. For simplicity, FIG. 2 shows motor 23 as a single phase ECM having a single phase winding 63. It is to be understood, however, that aspects of the present invention are contemplated for use with multi-phase motors.

The inverter bridge circuit 71 also has a positive, or upper, rail 85 and a negative, or lower, rail 87 supplied by power supply 57. A shunt resistor, current transformer, Hall-effect current sensor, integrated current sensor or other sensor or circuit known in the art may be used to sense the winding or motoring current of motor 23 for current regulation. It is to be understood that rails 85, 87, constitute a power supply link, also indicated by lines 59, 61, for providing power to the motor winding 63.

In addition, FIG. 2 illustrates a gate drive circuit, generally indicated 89, that is associated with the right side of bridge circuit 71 (i.e., switches 77, 81) and a gate drive circuit, generally indicated 91, that is associated with the left side of bridge circuit 71 (i.e., switches 75, 79). Although power switches 53, line 51 and gate drives 45 are illustrated separately in FIG. 1 for simplicity, it is to be understood that the bridge circuit 71 of FIG. 2 embodies aspects of each of these component.

As an example of the operation of motor 23, control circuit 39 provides control signals to enable a pair of power switches 53 (i.e., switches 77, 79 or switches 75, 81), each on an opposite side of winding 63. In normal operation, control circuit 39 selects one of the active power switches 53 to be used for controlling the motor current. One of the two active switches (e.g., switch 77 or switch 75) performs pulse width modulation (PWM) while the other (e.g., switch 79 or switch 81) remains in its on, or conducting, state for the entire commutation interval as commanded by the commutation logic. The polarity of the motor back EMF during this time interval is counter to the supply voltage so that the driving electromotive force to develop current in motor 23 is the supply minus the back EMF. In the illustrated embodiment, control circuit 39 applies control signals to switches 75, 77 as a function of the commutation and regulation signals. For example, a pulse width modulated signal is applied to switch 75 while a logic level low signal is applied to switch 77, and vice-versa. Although the conduction time of one or both of the conducting power switches may be pulse width modulated for controlling the current provided to motor winding 63, only lower switches 75, 77 are used for pulse width modulation in the illustrated embodiment. Commonly assigned U.S. Pat. No. 4,757,603 shows an exemplary PWM control of a motor.

The control circuit 39 applies a voltage to the gate of switch 77 through a resistor 95 (R17) to control the transistor's switching. In a preferred embodiment of the invention, the value of this lower turn-on resistor 95 is selected to cause lower switch 77 to turn on relatively slowly with respect to the speed at which upper switch 81 turns off. In a similar manner, an upper turn-on resistor 97 (R13), the value of which is much greater than that of resistor 95, causes upper switch 81 to turn on more slowly than the speed at which lower switch 77 turns off. The gate drive circuit 89 of inverter bridge 71 employs a voltage gain element, such as an NPN transistor 99 (Q08), for turning off upper switch 81 when lower switch 77 is conducting. Although connected to the respective arm of bridge circuit 71, the transistor 99 does not form part of the motoring current conduction path. When switch 77 is conducting, a shunt resistor 103 (R16) carries current from motor winding 63. The shunt resistor 103 allows the unimpeded flow of fly back current through the internal fly back diode of lower power switch 77 and eliminates the use of relatively large power diodes. This is particularly beneficial in small scale application.

The voltage gain element NPN transistor 99, which responds to a voltage drop across shunt resistor 103 when lower switch 77 initially draws current, accomplishes the function of forcing off the upper gate drive for switch 81. Although, the initiating current appears to be shoot-through current, its duration is limited (i.e., it has a transient nature) and it typically occurs only at each commutation of the motor drive. During subsequent PWM operation of lower switch 77, the initiating current is supplied by the upper fly back diode of switch 81 in the form of diode recovery current. A base resistor 105 (R15), connected to the base of the NPN gate turn-off transistor 99, limits the requirement for significant current flow to the initiation of the lower switch conduction. This prevents an overcurrent condition at the base-emitter junction of transistor 99.

In the illustrated embodiment, the gate drive circuit 91 operates in the same manner as the corresponding circuit 89. Gate drive circuit 91 includes a lower turn-on resistor 107 (R18) and an upper turn-on resistor 111 (R08) in combination with an NPN transistor 113 (Q07) and a shunt resistor 115 (R11). In this instance, a resistor 117 (R10) is connected to the base of the NPN gate turn-off transistor 113. According to the commutation strategy of the present invention, the direct switching of only the lower switches 75, 77 commutates and regulates the motor current. The states of upper switches 79, 81 automatically complement the states of lower switches 75, 77, respectively. By automatically controlling the upper gate drive, the combination of transistor 99 and resistors 95, 97, 103, 105 of the gate drive circuit 89 minimizes shoot-through currents which result if both switches 77, 81 are conducting at the same time. Likewise, the combination of the transistor 113 and resistors 107, 111, 115, 117 reduce shoot-through currents in switches 75, 79 in a manner similar to drive circuit 89.

Referring further to gate drive circuit 89, when the voltage drop across shunt resistor 103 exceeds the threshold for turning on NPN transistor 99, the resistor 103 informs transistor 99 of the current drawn by the respective lower power switch 77 through the base resistor 105. A positive feedback resistor 121 (R14) sustains base current drive to transistor 99 when the respective lower power switch 77 is on. The NPN gate turn-off transistor 99 pulls the voltage low that is supplied through gate resistor 97 when the biasing conditions at its base terminal produces adequate collector current.

FIG. 2 also illustrates preferred charge pump circuitry for turning on upper switch 81 when lower switch 77 is turned off. Preferably, a capacitor 123 (C06) charges to +15 volts via a high voltage diode 125 (D07) when switch 77 is conducting. This forms a “flying capacitor” or “charge pump” supply to produce the required bias for the upper power switch 81. In other words, the voltage across the capacitor 123 turns on upper switch 81 when lower switch 77 is turned off. A resistor 129 (R12) limits the current draw on the logic power supply when the capacitor 123 is being charged by the on state of the respective lower power switch 77.

With respect to the left side of the inverter bridge circuit 71, gate drive circuit 91 operates in a manner similar to gate drive circuit 89. In this instance, NPN transistor 113 turns on when the current drawn through base resistor 117 by lower switch 75 causes the voltage drop across shunt resistor 115 to exceed the threshold for turning on transistor 113. A positive feed back resistor 131 (R09) sustains base current drive to transistor 113 when the respective lower power switch 75 is on and the transistor 113 pulls the voltage low that is supplied through gate resistor 111 when the biasing conditions at its base terminal produces adequate collector current. Moreover, drive circuit 91 includes charge pump circuitry for turning on upper switch 79 when lower switch 75 is turned off. Preferably, a capacitor 133 (C05) charges to +15 volts via a high voltage diode 135 (D06) when switch 75 is conducting for turning on upper switch 79 when lower switch 75 is turned off. A resistor 139 (R07) limits the current draw on the logic power supply when the capacitor 133 is being charged by the on state of the respective lower power switch 75. It is to be understood that the two resistors 129 and 139 can be replaced by a single resistor located between the logic power voltage VCC and the connected anodes of diodes 125, 135.

Thus, for each arm of bridge circuit 71 (i.e., the upper and lower switches on the same side of the load), the state of the upper switch (i.e., switch 79 or switch 81) depends on the state of its corresponding lower switch (i.e., switch 75 or switch 77, respectively). In this manner, the present invention provides “hands off” control of upper switches 79, 81. The gate drive circuits 89, 91 of bridge circuit 71 also reduce the opportunity for non-transient shoot-through currents to be present by causing the upper switch of each arm to turn on at a slower rate than the rate that its corresponding lower switch turns off.

In FIG. 2, the transistors embodying switches 53 each have a gate electrode, a source electrode and a drain electrode. These transistors also include internal fly back diodes. Preferably, lower turn-on resistors 95, 107 are connected to the gate electrodes of lower switches 77, 75, respectively, and upper turn-on resistors 97, 111 are connected to the gate electrodes of upper switches 81, 79, respectively. The combination of capacitor 123 and diode 125 and the combination of capacitor 133 and diode 135 constitute charge pump circuits for turning on the respective upper switch 81, 79 in response to the corresponding lower switch 77, 75 on the same arm of bridge circuit 71 turning off. As illustrated, resistor 129 and diode 125 are connected between the upper turn-on resistor 97 and the +15 volt source and capacitor 123 is connected between resistor 129 and the drain electrode of the corresponding lower switch 77. Likewise, resistor 139 and diode 135 are connected between the upper turn-on resistor 111 and the +15 volt source and capacitor 133 is connected between resistor 139 and the drain electrode of the corresponding lower switch 75. In addition, drive circuits 89, 91 include the voltage gain elements, transistors 99, 113, connected between the gate electrode of the respective upper switches 81, 79 and the drain electrode of their corresponding lower switches 77, 75.

The rates at which the switches 53 of gate drive inverter bridge 71 turn on and turn off also provide advantages over conventional bridge circuits. Particularly, the turn-on rates of upper switches 81, 79 are slower than the turn-off rates of lower switches 77, 75, respectively. This means that switch 81 will turn on after switch 77 turns off and that switch 79 will turn on after switch 75 turns off. Thus, the gate drives embodied by bridge circuit 71 minimize unmanageable shoot-through currents without requiring a time gap between the control signals applied to switches 75, 77. In contrast to conventional gate drives, bridge circuit 71 does not include the use of a timer or the like to produce time gaps between the drive signals applied to power switches 53, i.e., a “dead time,” to reduce shoot-through current.

For these reasons, the present invention is particularly well suited for controlling motor torque or speed by pulse width modulating the lower switches 75, 77 of bridge circuit 71. As an example, upper switch 81 remains continuously on when lower switch 77 is off, i.e. when a logic level low signal is applied to the gate of switch 77. Meanwhile, lower switch 75 may be pulse width modulated for control purposes. Since the on state of upper switch 81 depends on the off state of lower switch 77, rather than the on or off state of lower switch 75, switch 81 remains on even when switch 75 is being pulse width modulated. Advantageously, switch 81 is not switched on and off needlessly during the pulse width modulation of switch 75.

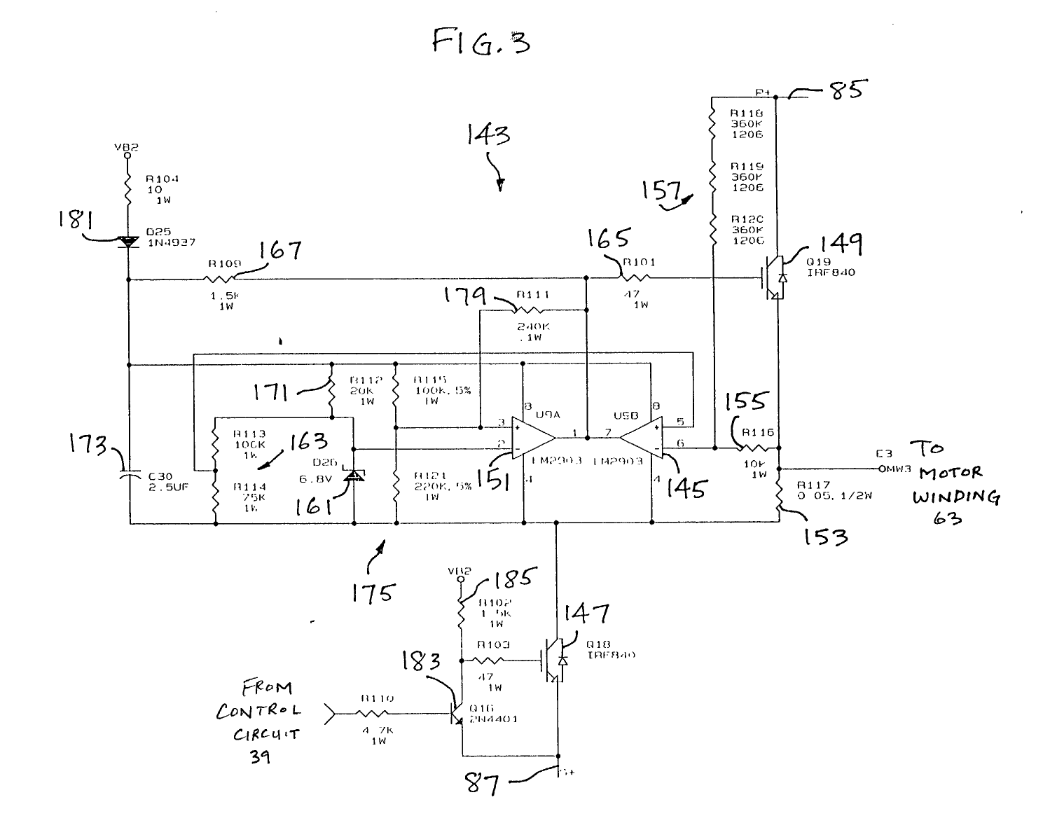

Referring now to FIG. 3, another preferred embodiment of the present invention includes a gate drive circuit 143 employing a comparator 145 (U9B) as its voltage gain element. For simplicity, FIG. 3 shows a single phase leg having a lower power switch 147 (Q18) and an upper power switch 149 (Q19). As described below, a dual comparator circuit, including a comparator 151 (U9A) in addition to the comparator 145, facilitates under voltage protection of the upper switch 149. A shunt resistor 153 (R117) measures current in the lower switch 147 for effecting a state change by the voltage gain element comparator 145, which is operated through a resistor 155 (R116) connected to its inverting terminal (pin 6). In this embodiment, a series resistor network 157 (R118, R119, R120) constitutes a positive feedback resistance. The output (pin 7) of comparator 145 pulls the gate of the upper power switch 149 low when the voltage across the shunt resistor 153 (as reflected through the resistor network 157) exceeds the reference voltage on the non-inverting input (pin 5) of comparator 145. According to the invention, a zener diode 161 (D26) and a voltage divider 163 (R113, R114) establish the reference voltage.

By using comparator 145 as the voltage gain element, the gate drive circuit 143 does not require a diode forward voltage drop to activate. Thus, circuit 143 permits a lower activation threshold voltage across the shunt 153, which reduces insertion loss for the circuit. In particular, a lower activation threshold (e.g., approximately 50 mV) permits the use of a lower value current shunt resistor 153 (e.g., approximately 50 mΩ). In contrast, the threshold for switching transistor 99, 113, is approximately 0.8 to 1.2 V. As a result, the present invention as embodied by the gate drive circuit 143 of FIG. 3 is particular well suited for applications at relatively higher power levels (e.g., operating current of approximately 2.25 A rather than approximately 0.2 A in a low power application). For example, the insertion loss is about 2.25 W with a one volt activation level whereas the insertion loss is about 0.25 W in a low power application with the lower activation level. For higher current operation, shunt resistor 153 can be scaled down to minimize insertion loss.

Referring further to FIG. 3, a resistor 165 (R101) limits the current drawn by either comparator 145, 151 when discharging the gate of upper switch 149. A resistor 167 (R109) pulls the gate up (turning switch 149 on) when permitted by comparators 145, 151 and a resistor 171 (R112) sources current to the zener 161. Comparator 151 provides under voltage gate drive protection when the voltage of a capacitor 173 (C30) falls below a threshold voltage (e.g., approximately 9 V) as established by a resistor network 175 (R115, R111, R109, R121). A resistor 179 (R111) provides hysteresis so that the capacitor 173 is recharged to a nominal level of about 12.7 V before re-enabling operation of the upper gate. A high voltage diode 181 (D25) and capacitor 173 provide the charge pump supply as described above with respect to the cross coupled gate drive 71 of FIG. 2. In the alternative, gate drives 71, 143 employ isolated transformer windings for voltage source instead of charge pump supplies.

In a preferred embodiment of the present invention, capacitor 173 is sized larger than the capacitors 123, 133 of FIG. 2 because comparators 145, 151 and the additional network of gate drive circuit 143 use a greater total bias current. As shown in FIG. 3, an NPN transistor 183 (Q16) with a pull up resistor 185 (R102) drives lower gate switch 147 in response to motor control signals from control circuit 39. This relatively simple voltage gain element, transistor 183, permits a 5 V source, such as a microcomputer or DSP, to drive circuit 143.

As described above, FIG. 3 shows only one phase leg for simplicity. Combined with a center tap power supply, the gate drive circuit 143 can sustain single phase operation. However, gate drive circuit 143 is preferably doubled for single phase H-bridge operation or tripled for three phase operation.

The application of the cross coupled gate drive schemes of FIGS. 2 and 3 to three phase ECM applications is complicated by the intrinsic 180° electrical conduction of the concept. For single phase ECM applications, as well as three phase variable speed induction motor drives and three phase sine wave ECM drives (sinusoidal distributed windings and flux), 180° conduction is standard procedure. However, for three phase ECM applications, 120° conduction accommodates back EMF position sensing and allows current regulation by a single shunt resistor positioned in the negative rail 87. In addition, 120° conduction avoids complications in circulating current that would otherwise occur during 180° conduction. Therefore, a three phase ECM drive providing the benefits of a cross coupled gate drive is desired.

In general, application of cross coupled gate drive circuitry results in a 180° conduction scheme. One example of the direct application of such circuits for driving motor 23 involves the use of a single current sensing shunt resistor in the negative rail 87 for controlling motor current. In this example, PWM control of current is established by turning on all the inverter bridge's lower power switches when the current is observed to exceed a desired threshold. Turning off one of the lower power switches after an appropriate interval (established either by an off timer of an asynchronous PWM timer) reestablishes source current. It is to be understood that it may be appropriate during some intervals to turn off two lower switches in a three phase application. Although this approach performs acceptably for higher current levels, significant issues develop at lower current levels.

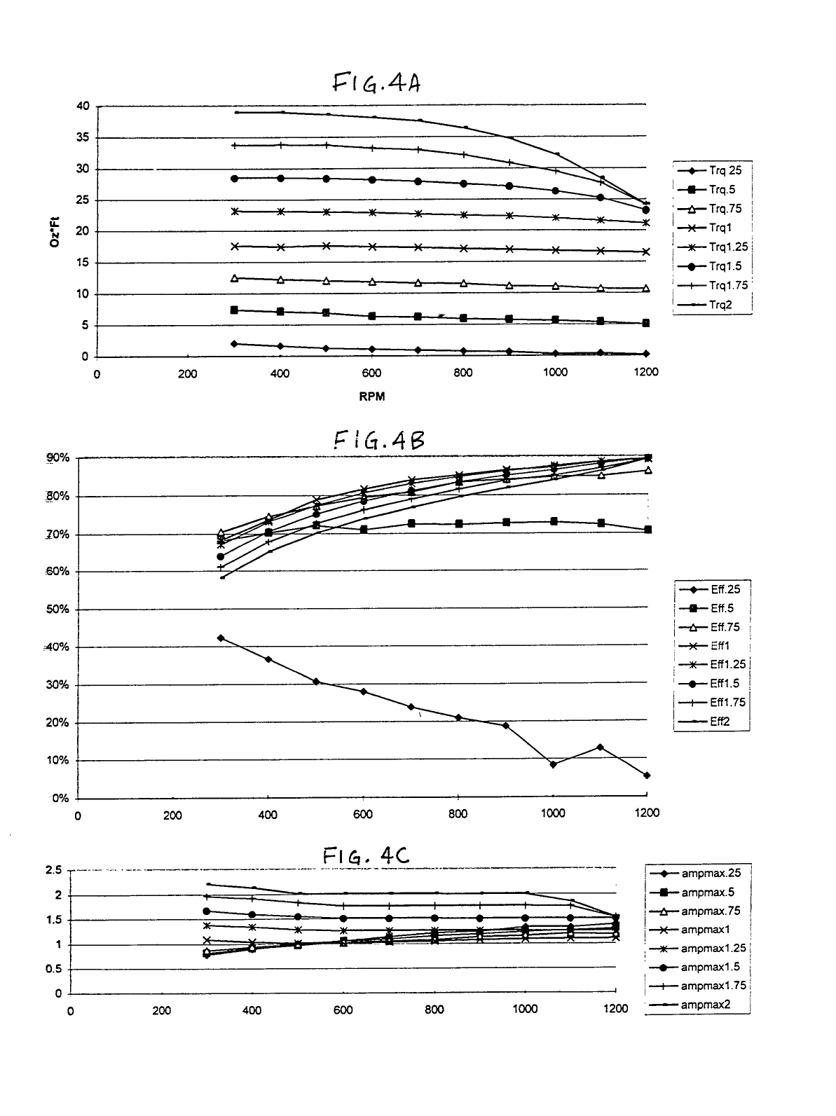

FIGS. 4A-4C illustrate exemplary operation of motor 23 with a single resistive shunt in the negative rail 87 for activating turn-on of all of the lower switches (e.g., switch 147 corresponding to each phase). As described above, turning on the lower switches of power switches 53 provides a means for limiting current in a three phase ECM control. FIG. 4A plots torque versus speed and peak current regulate level and demonstrates the desired characteristic of having motor torque controlled by peak current over a broad speed range.

FIG. 4B plots efficiency versus speed and peak current regulate and demonstrates relatively efficient operation above 0.5 A peak regulate. FIG. 4C presents the observed maximum phase amps versus speed and peak regulate amps. Although the observed maximum phase amps reduces in correspondence to the peak regulate value from 2 A to 1 A, attempts to regulate below 1 A do not significantly reduce the observed maximum phase amps below 1 A.

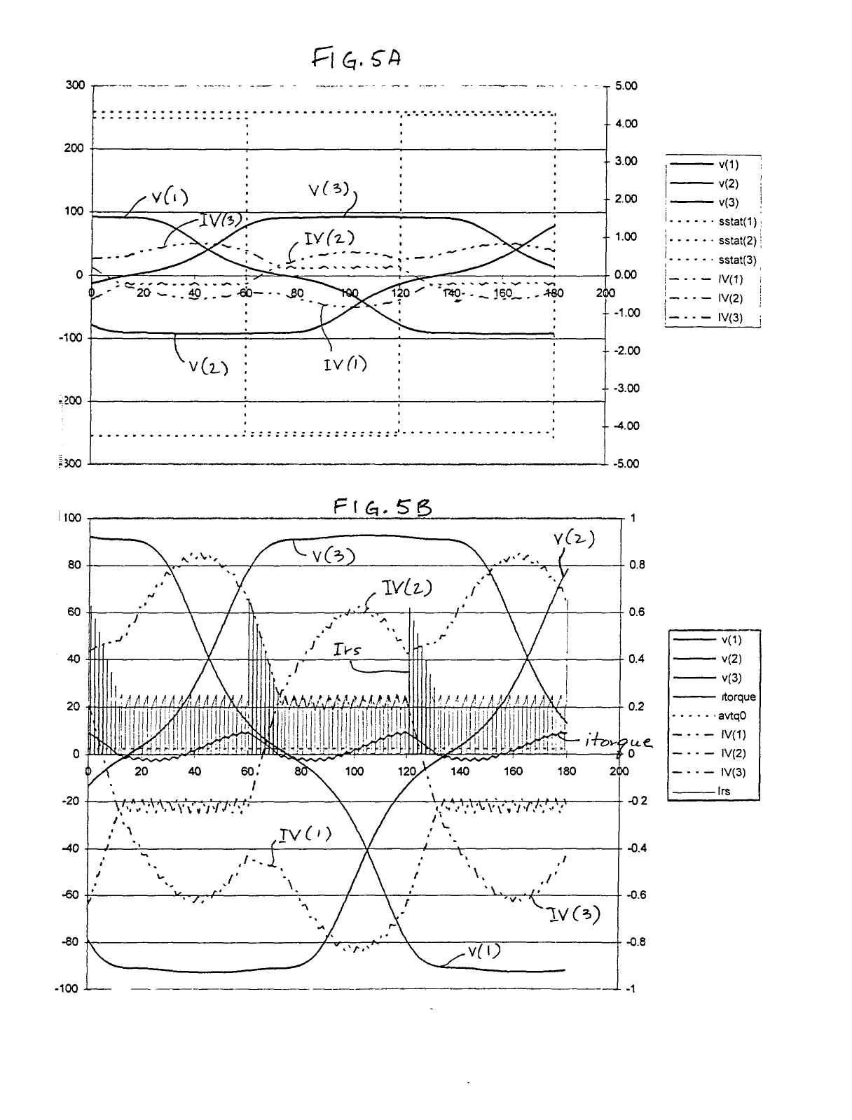

Referring now to FIGS. 5A and 5B, exemplary phase currents and voltages, respectively, are shown with respect to rotation (in electrical degrees) at 0.25 A peak regulate level. FIG. 5A shows trapezoidal phase back EMF and phase currents for the motor windings 63 and basic inverter voltage states versus electrical degrees. FIG. 5A also shows the currents that do not respond to the effort to regulate below a level of one amp. FIG. 5B adds the instantaneous and average torque and the shunt current to the data of FIG. 5A. It can be seen from the plot of FIG. 5B that one of the phase currents responds to the regulation of the shunt 15. current at any one time but the other two phases are circulating current between themselves out of the view and control of the current regulator.

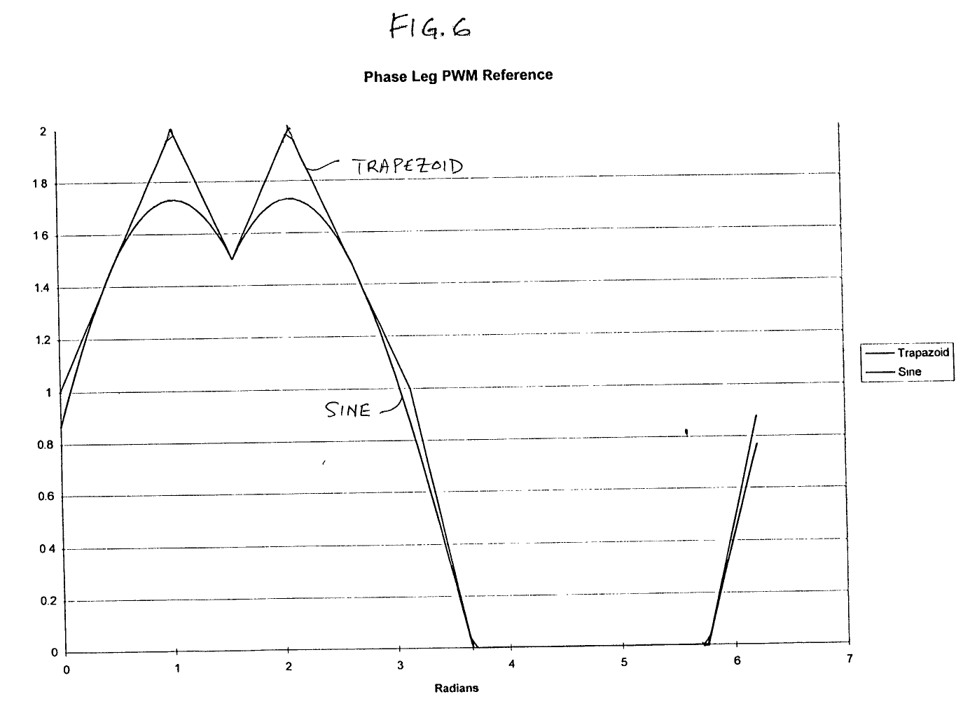

Referring now to FIG. 6, the present invention provides improved gate drive response for three phase ECM applications by establishing phase voltage regulation of the type usually employed for variable speed induction motor (VSIM) drives. An appropriate sequence of phase voltages applied to the three phase electronically commutated motor 23 produces currents that satisfy the general requirements for efficiency and controlled torque. FIG. 6 illustrates two alternative sequences of phase leg PWM reference for the generation of appropriate phase voltages. Each sequence corresponds to only one leg of the three phase drive. The two phase legs not shown may be derived directly from the specific sequence demonstrated in FIG. 6 by consecutively shifting the sequence by 120° (2.094 radians). The trapezoidal and sine wave sequences are both derived from the form of the voltage that is presented to the motor phase to neutral of the Y-connected windings 63 of motor 23. These voltages are shown as referenced to the inverter negative rail 87 with the requirement that the phase with the most negative instantaneous value is set at zero with reference to negative rail 87. As shown, both sequences are zero for the interval from about 3.67 to 5.76 radians (an interval of approximately 2π/3 radians). By setting the voltage of one of the three phases to zero, operation according to FIG. 6 provides numerous advantages. For example, the voltage available for driving motor 23 is maximized, efficiency is improved because the total amount of PWM switching is minimized and individual phase leg shunts placed between negative rail 87 and the lower power switch/fly back diode (e.g., switch 147) provide information regarding the complete motor phase current during the interval that the phase is set to zero volts.

In FIG. 6, the first sequence is based on a trapezoidal wave of voltage presented to the motor phase to neutral and the second sequence is based on a sine wave of voltage presented to the motor phase to neutral. The sequences are distinguished by the pointed characteristic of the trapezoidal form versus the rounded form of the sine wave. In VSIM drives, for example, the sine wave form is preferred due to the need to minimize harmonics in an induction motor drive to maximize efficiency. In an electronically commutated motor (especially with non-sinusoidal back EMF waveforms), there is no similar premium for minimization of harmonics with regard to efficiency.

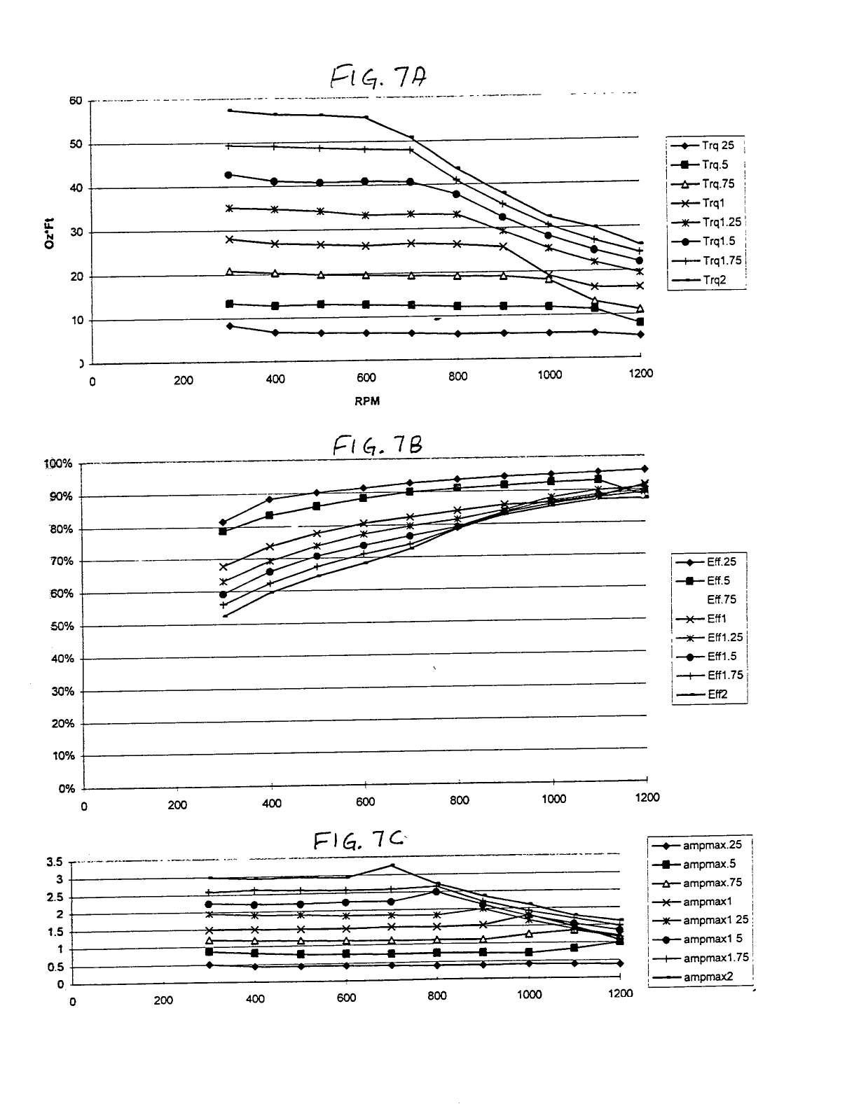

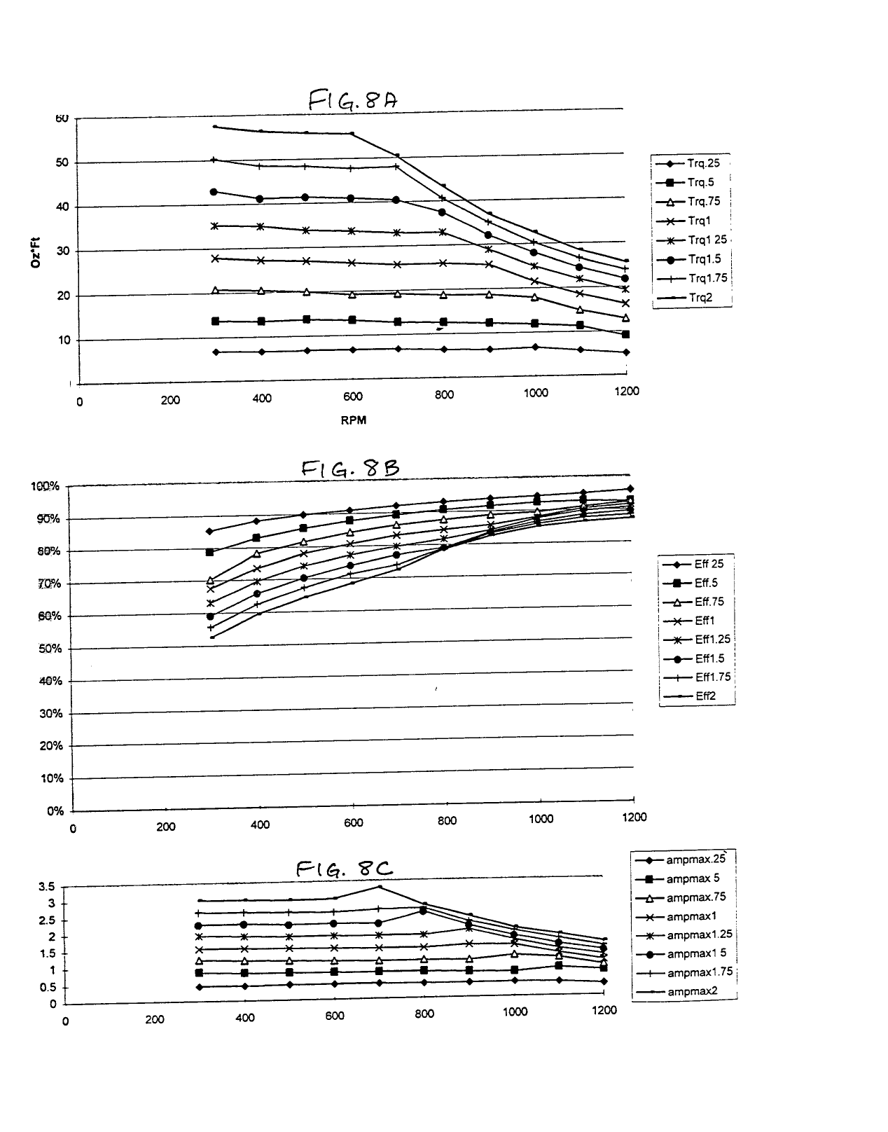

FIGS. 7A-7C and FIGS. 8A-8C illustrate three concurrent plots of exemplary motor operation according to the two phase voltage sequences of FIG. 6. In particular, FIGS. 7A-7C show the operation of motor 23 when regulated based on a sine wave voltage duty cycle and FIGS. 8A-8C show the operation of motor 23 when regulated based on a trapezoidal phase voltage. FIGS. 7A and 8A illustrate motor torque with respect to motor speed and nominal current regulate levels. FIGS. 7B and 8B plot efficiency versus speed and nominal current regulate level and FIGS. 7C and 8C plot the maximum observed phase current versus speed and nominal current regulate level. In contrast to FIGS. 4A-4C, the exemplary plots of FIGS. 7A-7C and 8A-8C are not based on the instant regulation of the peak current in negative rail 87. Rather, these plots illustrate motor operation by adjusting the phase leg PWM values in response to the observed current in the negative rail 87. In essence, this provides a delayed servo response, which introduces loop stability implicit in such systems. A comparison of FIGS. 7A-7C to FIGS. 8A-8C reveals that the less complex trapezoidal form is not significantly different from the sine wave sequence. In a preferred embodiment, control circuit 39 (e.g., a DSP) implements one of the voltage regulation approaches of FIGS. 7A-7C and FIGS. 8A-8C for operating motor 23.

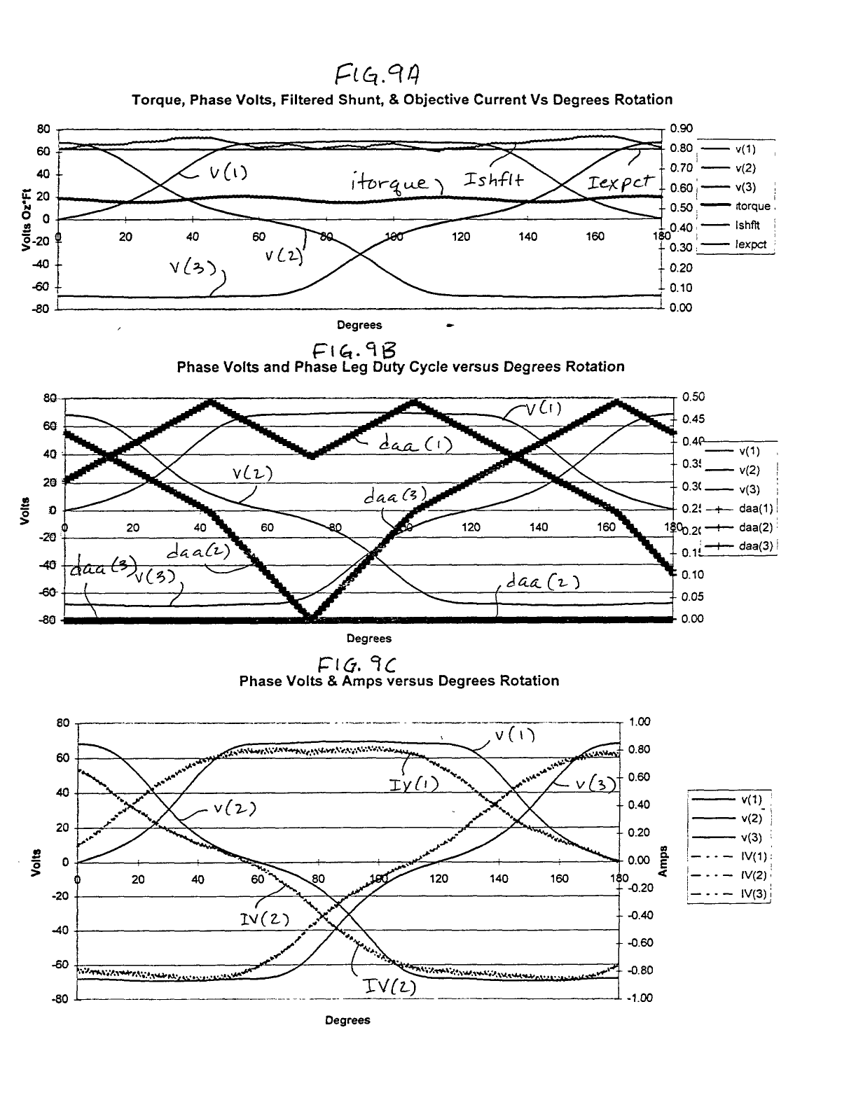

FIGS. 9A-9C illustrate exemplary voltages, currents and phase leg duty cycle during trapezoidal operation. For reference, each of the plots has the back EMF voltages of the three phases plotted with respect to the rotation of rotor 27 (in electrical degrees). FIG. 9A shows that motor 23 generates, for example, about 20 Oz*Ft of torque. FIG. 9A also shows the filtered peak values of shunt current plotted with respect to a target value of 0.8 A (the Y axis to the right). FIG. 9B includes the per unit duty cycle for each phase leg plotted and FIG. 9C plots the phase currents.

For low cost and improved efficiency, three phase electronically commutated motors are designed with salient pole construction. This construction calls for each of the salient stator phase poles to return its flux through the other two phase saliencies and is often referred to as a “consequent pole design.” There are half as many stator saliencies as there are phases times poles in this construction. For example, a 12 pole, three phase consequent pole stator has 18 saliencies.

Commonly assigned U.S. Pat. No. 5,796,194 discloses a single phase motor having a quadrature axis winding that extends through a notch in each of the motor's stator teeth. The direction in which the quadrature axis winding is wound alternates for adjacent teeth. In other words, the quadrature axis winding for a single phase salient pole motor is positioned in the center of each saliency. Since a consequent pole design of a three phase motor also means that each of the stator phase poles are wound in the same direction, this initially suggests a dilemma in the placement of quadrature windings 69.

As described above, conventional trapezoidal phase voltage strategies for three phase motors require the tracking of rotor position. For example, three Hall sensors in proximity to the edge of the rotor magnet may be used to estimate the rotation angle by elapsed time as referenced to the previous commutation interval. Likewise, three optical interrupters and a shaft mounted shutter may also be used to estimate rotation angle. According to the present invention, quadrature axis windings 69 provide rotor position feedback. FIG. 10 is a flattened sectional top view of motor 23. In this instance, motor 23 is a three phase motor having main windings 63 designated A, B, and C and an additional coil for sensing position (i.e., quadrature axis winding 69) corresponding to each phase. Both the main and the quadrature axis windings 63, 69 are electromagnetically affected by magnet flux of rotor 27. However, quadrature windings 69 are not electromagnetically affected by magnet flux of stator 25. This allows quadrature windings 69 to detect the position of rotor 27 without being affected by currents in main windings 63. Both sets of windings are electromagnetically affected by the magnet flux of rotor 27 because the direction of flux to or from rotor 27 due to each rotor magnet depends on the polarity of the rotor magnet adjacent a respective portion of stator 25. In one embodiment, stator 25 has a plurality of teeth 189, each having three notches. Quadrature axis windings 69 are wound between the center notches of the teeth 189 as shown in FIG. 10.

According to the present invention, motor 23 returns the respective quadrature winding 69 through the slot between the other two phases. As shown in FIG. 10, the cross end for each of the quadrature winding phases is placed in the center of the stator saliencies. FIG. 10 also shows the dot end for each phase as returning between the windings 69 of the opposite two phases. The final termination of windings 69 returns into a common connection (not shown) to complete a Y-connected configuration for the quadrature windings 69. In operation, the three Y-connected quadrature windings 69 develop a reference set of voltages. These quadrature phase voltages provide information for estimating the angular position of rotor 27 based on elapsed time as referenced to a previous commutation interval. In addition, the quadrature winding voltages may be integrated to achieve an in-phase set of voltages to be used as references for regulation of each of the phase currents. In one embodiment, control circuit 39 constitutes an integrator.

As an example, control circuit 39 provides the estimation of the angular position of rotor 27 in combination with an commutation advance angle calculated based on the principles disclosed in commonly assigned U.S. Pat. No. 5,796,194. In this example, a trapezoidal voltage sequence presented to the motor phases produces results as shown in FIGS. 9A-9C. Advantageously, the present invention employs the information obtained from quadrature windings 69 for shaping the motoring current in addition to position sensing. This form of regulating current can reduce the amount of torque harmonics normally seen for 120° conduction schemes.

In one preferred embodiment of the present invention, control circuit 39 implements low pass filtering of the quadrature voltages (either by conventional analog circuitry or computationally by a DSP, for example) so that the reference voltages are in phase with the motor back EMF. By having voltages representative of the back EMF phase voltages, motor system 21 can regulate phase currents to a scaled value of the phase voltages. Advantageously, in-phase reference voltages permit controlling currents through the critical sequences between rotational states and also provides for automatic advance angle compensation.

As an alternative to isolated current measurements, separate phase shunts connecting the negative rail 87 to the three lower power switches (e.g., switch 147) and their corresponding fly back diodes present the correct phase current when the lower power switch or fly back diode is conducting. The shunts, however, have no current present when the upper power switches (e.g., switch 149) are on. In the cross coupled gate drive scheme described herein, the correct current can be observed whenever the lower power switch is controlled to be on. For this reason, control circuit 39 (e.g., a DSP) provides a preferred means for implementation of a control based on regulating the current to match a scaled value of the low pass filtered quadrature winding voltages. In a DSP, the PWM period is constrained to less than 100% duty cycle for any phase leg. At the beginning of each PWM cycle, samples of the shunt currents are recorded during a time when all the lower power switches are active. For a low cost DSP, each phase sample may require about three microseconds. Thus, the total sample time is about nine microseconds for all three phases or about six microseconds for two phases. Since one of the lower power switches of the three phases is selected to remain on during the PWM cycle, it would not have to be measured during the interval in which all lower switches are on.

After sampling the current, control circuit 39 preferably initiates the PWM period. In one embodiment, control circuit 39 selects one of the three phase legs to have the respective lower power switch turned on throughout the PWM interval. Control circuit 39 makes this selection by determining which phase current requires the most negative correction when compared to the current goal as set by the scaled low pass filtered quadrature voltages. Turning on the remaining upper power switches that require positive phase current correction initiates the PWM period. During the interval that the upper switches are conducting, the respective phase currents in the legs that have the upper switches conducting can be estimated if not measured.

Estimating the current employs the time into the PWM cycle, the phase inductance (increased by the inter-phase winding coupling), the voltage estimated for the phase back EMF by the quadrature voltage and the assumed or measured rail voltage. For more accuracy, the measured voltage at the center connection of the Y-connected main windings 63 may also be incorporated. In general, the duty cycles can be restrained to discrete selections of duty cycle to as high as 45%, for example. An uncontrolled, rapid rise of current can be observed by the shunt of the phase leg selected to have the lower power switch on throughout the PWM period, and if it exceeds the desired regulate value, employed to terminate the conduction of all of the upper power switches.

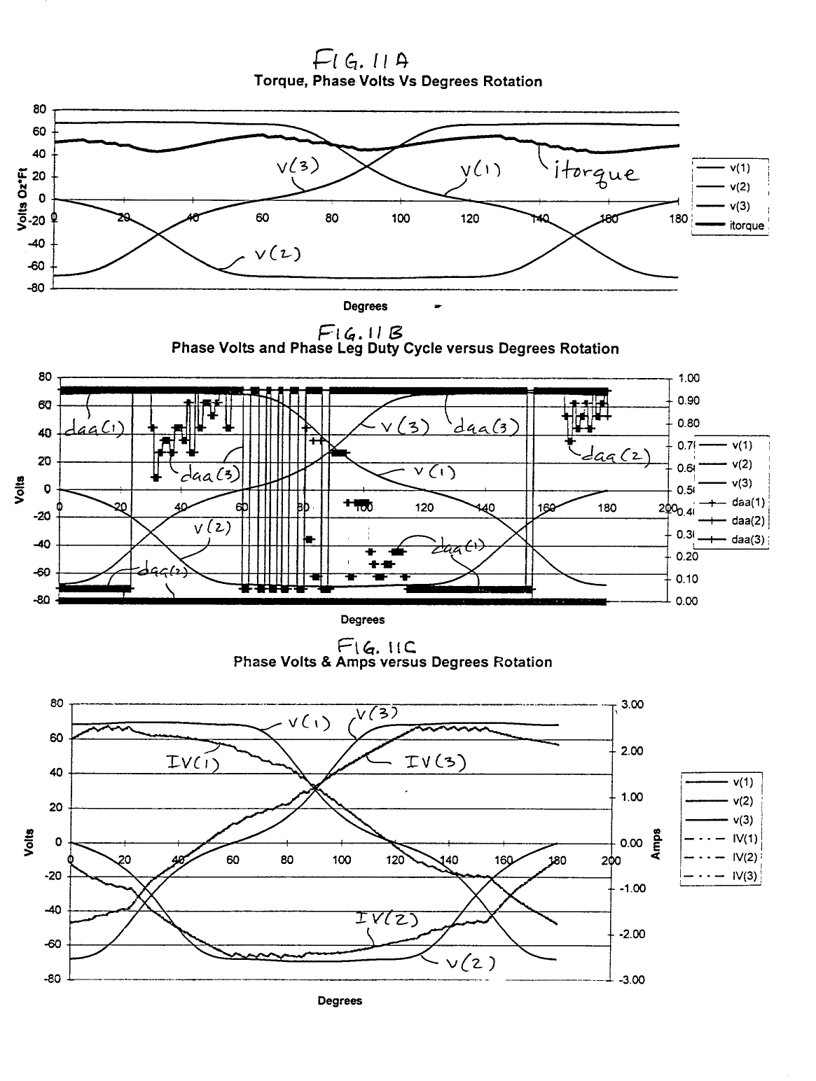

Referring now to FIGS. 11A-11C, exemplary voltages, currents and phase leg duty cycle are shown. For reference, each of the plots has the back EMF voltages of the three phases plotted with respect to the rotation of rotor 27 (in electrical degrees). FIG. 11A shows that motor 23 generates, for example, about 50 Oz*Ft of torque. In this instance, control circuit 39 monitors current via three shunts so the filtered peak values of current are not plotted. FIG. 11B includes the per unit duty cycle for each phase leg plotted and FIG. 9C plots the phase currents. Preferably, control circuit 39 determines the duty cycles based on the regulation of the estimated phase current to a target value obtained from the scaled, low pass filtered quadrature voltages.

Operation of motor 23 based on position sensing by quadrature windings 69, however, is not self starting. At start-up, quadrature winding voltages are zero. Thus, any value of current scaled to the low pass filtered quadrature winding voltages will also be zero. A preferred start-up method incorporates a six state sequence of positive, zero value, and negative current goals or targets. In this instance, control circuit 39 controls commutation between states by a summation of Volt*Seconds as determined by a sequence of the estimated phase volts derived from the quadrature voltages.

One exemplary sequence is: 0, 1, 1, 0, −1, −1 for states 0 through 5 for phase 1 (or phase A). Phase 2 (or phase B) is two states advanced from phase 1 in the same sequence, and phase 3 (or phase C) is two states advanced from phase 2. In this instance, the sequence represents a set of coefficients by which desired peak current levels are multiplied. The estimated phase voltages are derived from the filtered quadrature winding voltages by the following:

First, an RC divider has the following divider ratio for the steady state. In complex arithmetic form for the fundamental:

Vc=Vq*(−jXc)/(R−jXc)

Where Vc is across the capacitor; and Vq is the quadrature voltage.

Discarding the angles for the magnitude of the divider ratio and dividing by Xc and Vq:

Vc/Vq=1/sqrt((R/Xc)ˆ 2+1)

Substituting 1/wC for Xc:

Vc/Vq=1/sqrt((R*C*w)ˆ 2+1)

Where w=2π*Poles*RPM/120.

Substituting Vq=Vph/n and λ=R*C where n is the effective turns ratio phase winding/quadrature coil:

Vc*n/Vph=1/sqrt((λ*w)ˆ 2+1)

Solving for Vph:

Vph=Vc*n*sqrt((λ*w)ˆ 2+1)

Control circuit 39 then employs this estimate of the phase voltage for the selected phase to sum the Volt*Seconds for commutation. Only Volt*Second summation above zero is allowed with negative summation below zero inhibited. Control circuit 39 determines the phase selected for Volt*Second summation by the state assigned to phase 1 in the previous current goal sequence. The following sequence for states 0 through 5 (as selected by the state assigned to phase 1) determines the phase voltage estimate to sum, with the summation direction determined by the sign attached to the phase number in this sequence: −1, 2, −3, 1, −2,3.

In the alternative, control circuit 39 directly sums the low pass filtered quadrature voltages for Volt*Seconds when λ*w is small at start-up:

Vph=Vc*n*k

Where k is derived experimentally for acceptable starting performance.

If commutation is not developed by Volt *Second summation within an appropriate time limit, control circuit 39 preferably employs a forced commutation. The start-up algorithm persists only to a predetermined speed, such as 100 RPM, after which operation diverts to the regulation of current to a scaled value of the low pass filtered quadrature voltage.

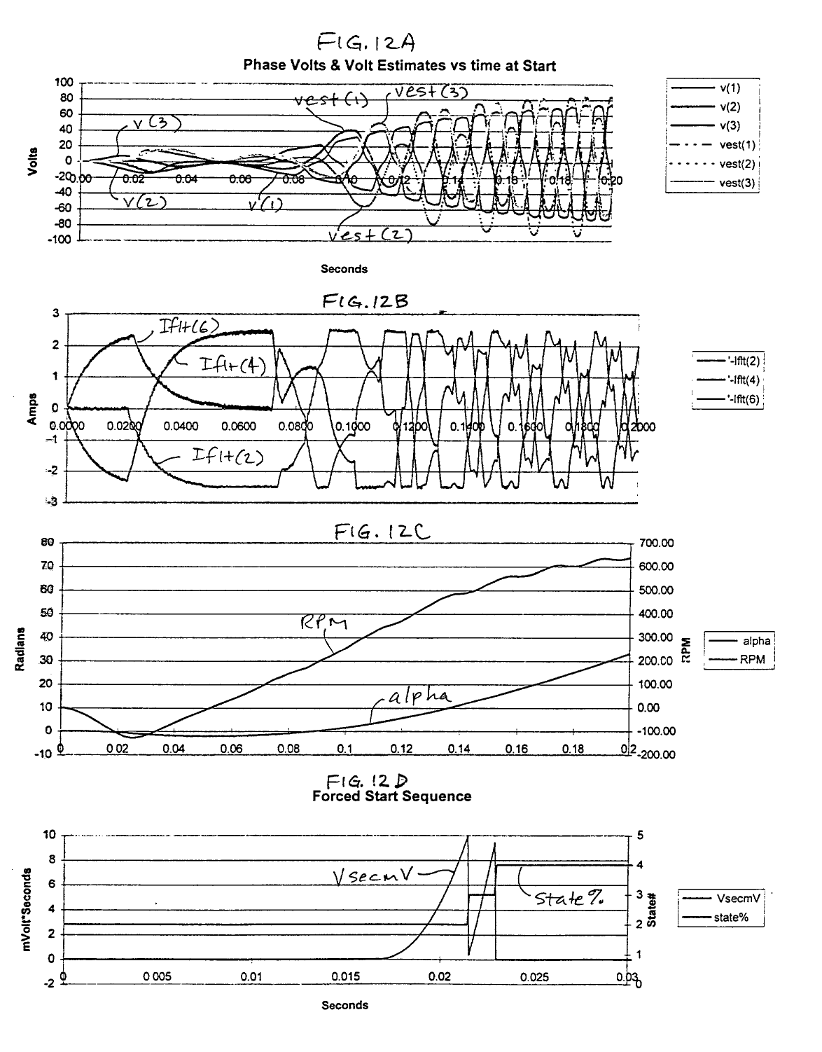

FIGS. 12A-12D illustrate the exemplary operation of motor 23 starting in this manner. FIG. 12A includes the back EMF versus the estimate of back EMF derived from the low pass filtered quadrature voltages. As an example, the low pass filter has a time constant of 0.1 second, which corresponds to 100 RPM for a 12 pole, three phase motor. As can be seen from this plot, the angle of these estimates is acceptable. Although not illustrated in FIG. 12A, control circuit 39 preferably provides digital or analog derived computations for clamping of the low pass filter output to expedite centering of the phase voltage estimates. With clamping at values determined by a centering algorithm, control circuit 39 (e.g., a DSP) preferably performs a pure integration to achieve the desired phase voltage estimates. FIG. 12B shows the simulated phase currents at start-up and demonstrates the intervention of a peak current limit based on observation of the shunt of the phase leg selected to have the lower power switch on. Asymmetry in the starting currents reflect the asymmetries in the phase voltage estimates, which can be substantially corrected by the means described above. FIG. 12C shows an exemplary reversal and correction in rotation direction at start-up. Such a reversal may occur due to an “out of position” start. The reversal is seen in the negative RPM from 0 to 0.055 seconds, and the negative angle from 0 to 0.09 seconds. The acceleration variations beginning at about 0.12 seconds are attributable to the previously discussed current asymmetries. FIG. 12D illustrates only the first 0.03 seconds while the start-up algorithm is active. A parameter mV*Seconds is shown being summed to produce the first state change at 0.0215 seconds, and the second at 0.023 seconds.

These plots are based on a four wire connection to the three phase quadrature windings 69. For three wire connection (the center connection of the Y-connected three phase is omitted), three equal resistors are used to sum to an artificial center point. The voltages that exist from this summed center point to the three terminals may have significant instantaneous errors as estimates of the source Y-connected voltages. However, the low pass filtered voltages derived from these approximate voltages are generally indistinguishable from those derived directly from the source Y-connected quadrature voltages.

In view of the above, it will be seen that the several objects of the invention are achieved and other advantageous results attained.

As various changes could be made in the above constructions and methods without departing from the scope of the invention, it is intended that all matter contained in the above description or shown in the accompanying drawings shall be interpreted as illustrative and not in a limiting sense.

What is claimed is:

1. A motor system comprising:
a rotatable assembly;
a stationary assembly in magnetic coupling relation to the rotatable assembly, said stationary assembly including at least one winding;
a power supply link having an upper rail and a lower rail supplied by a power supply;
a bridge circuit including a set of upper power switches connected between the winding and the upper rail and a set of lower power switches connected between the winding and the lower rail, each of said lower switches corresponding to one of said upper switches on the same side of the winding as the lower switch, said corresponding upper and lower switches connected to the same end of the winding defining an arm of the bridge circuit, said switches each having a conducting state and a nonconducting state wherein the state of each upper switch is determined by the state of its corresponding lower switch on the same arm of the bridge circuit;
a control circuit for generating a motor control signal to control the switches, said lower switches receiving and responsive to the motor control signal; and
a drive circuit responsive to the state of the lower switches for driving the corresponding upper switches to selectively connect the rails of the power supply link to the winding whereby the winding is energized with a motoring current to produce an electromagnetic field for rotating the rotatable assembly relative to the stationary assembly, said drive circuit including a voltage gain element connected to each arm of the bridge circuit, said voltage gain elements each being responsive to current in the respective lower switch for maintaining the corresponding upper switch on the same arm of the bridge circuit in its nonconducting state.

2. The motor system of claim 1 further comprising a resistive shunt in each arm of the bridge circuit, each of said resistive shunts being connected between the winding and the respective lower switch for sensing the current in the lower switch.

3. The motor system of claim 2 wherein each of the voltage gain elements is connected between the winding and the respective resistive shunt and responsive to a threshold voltage across the resistive shunt for causing the respective upper switch to become nonconducting.

4. The motor system of claim 1 wherein the upper switches each have a gate electrode for determining its state and wherein the voltage gain elements are each connected to the respective upper switch so that the voltage gain element pulls the gate electrode of the respective upper switch low when the current in the respective lower switch exceeds a threshold level thereby causing the respective upper switch to become nonconducting.

5. The motor system of claim 1 wherein the voltage gain element comprises a transistor connected to each of the upper switches, said transistors each having a conducting state and a nonconducting state, and wherein the upper switches are responsive to the conducting states of the transistors for becoming nonconducting.

6. The motor system of claim 5 wherein the transistors each have a base electrode for determining its state and further comprising a base resistor connected between the respective resistive shunt and the base electrode of each transistor for limiting the base electrode current.

7. The motor system of claim 6 further comprising a positive feedback resistor connected between the upper rail and the base electrode of each transistor for sustaining base current drive to the transistor when the respective lower switch is conducting.

8. The motor system of claim 1 wherein the voltage gain element comprises a comparator circuit connected to each of the upper switches, said comparator circuits each having a low level output state and a high level output state, and wherein the upper switches are responsive to the low level output states of the comparator circuits for becoming nonconducting.

9. The motor system of claim 8 wherein the comparator circuits each have an input for determining its state relative to a reference level and further comprising a resistor connected between the respective resistive shunt and the input of each comparator circuit for limiting the input current.

10. The motor system of claim 8 wherein the comparator circuit comprises a pair of comparators connected together at their outputs for providing under voltage protection to the bridge circuit.

11. The motor system of claim 1 wherein the lower switches each have a fly back diode coupled thereto and wherein the voltage gain elements are each responsive to diode recovery current for the respective lower switch for maintaining the corresponding upper switch in its nonconducting state.

12. The motor system of claim 1 wherein the winding comprises a single phase winding and wherein the bridge circuit comprises an H-bridge having two upper switches and two lower switches for selectively connecting the single phase winding to the power supply link.

13. The motor system of claim 1 wherein the winding comprises one of three interconnected phase windings and wherein the bridge circuit comprises a full inverter bridge having at least three upper switches and at least three lower switches for selectively connecting the three phase windings to the power supply link.

14. The motor system of claim 13 wherein the motor control signal defines commutation intervals during which one of the lower switches and one of the upper switches from different arms of the bridge circuit are conducting to connect the winding to the upper and lower rails of the power supply link, said commutation intervals being defined as a function of angular position of the rotatable assembly, and further comprising a quadrature axis winding corresponding to each of the three phase windings, each of said quadrature axis windings being in magnetic coupling relation with the rotatable assembly and positioned for generating an output signal representative of the angular position of the rotatable assembly.

15. The motor system of claim 14 further comprising an integrator for phase-retarding the output signals of the quadrature axis windings, said integrated output signals being representative of back electromotive force in the respective phase windings, and wherein the control circuit is responsive to the integrated output signals for generating the motor control signal to regulate the motoring current in each of the three phase windings.

16. The motor system of claim 14 wherein the stationary assembly includes a plurality of stator teeth defining slots therebetween, said phase windings being sequentially wound on the teeth so that one of the three phase windings is positioned on each tooth and two of the three phase windings are positioned in the each slot, each of said teeth having a centrally situated notch in its face, and wherein the quadrature axis windings are sequentially positioned in the notches of the stator teeth.

17. The motor system of claim 16 wherein the quadrature axis winding corresponding to one of the three phase windings is positioned in the slot in which the other two phase windings are positioned.

18. The motor system of claim 14 wherein the quadrature axis windings comprise a Y-connected circuit.

19. The motor system of claim 14 wherein the motor control signal generated by the control circuit implements a start-up sequence for starting the motor in the absence of the output signals from the quadrature axis windings at start-up, said start-up sequence defining a sequence of target current levels in the phase windings based on a desired starting torque.

20. The motor system of claim 1 further comprising a shaft in driving relation with the rotatable assembly for driving a rotatable component.

21. A gate drive for driving a motor, said motor having a rotatable assembly and a stationary assembly in magnetic coupling relation thereto, said stationary assembly including at least one winding, said motor also having a power supply link that includes an upper rail and a lower rail supplied by a power supply and having a control circuit for generating a motor control signal to control commutation of the winding, said gate drive comprising:
a set of upper power switches connected between the winding and the upper rail;
a set of lower power switches connected between the winding and the lower rail, said lower switches receiving and responsive to the motor control signal, each of said lower switches corresponding to one of said upper switches on the same side of the winding as the lower switch, said switches each having a conducting state and a nonconducting state; and
a drive circuit responsive to the state of the lower switches for driving the corresponding upper switches to selectively connect the rails of the power supply link to the winding whereby the winding is energized to produce an electromagnetic field for rotating the rotatable assembly relative to the stationary assembly, said drive circuit including a voltage gain element connected to each of the lower switches, said voltage gain elements each being responsive to current in the respective lower switch for maintaining the corresponding upper switch on the same arm of the bridge circuit in its nonconducting state.

22. A three phase motor system comprising:
a rotatable assembly;
a stationary assembly in magnetic coupling relation to the rotatable assembly, said stationary assembly including three phase windings;
a quadrature axis winding corresponding to each phase winding, each of said quadrature axis windings being in magnetic coupling relation with the rotatable assembly and positioned for generating an output signal representative of angular position of the rotatable assembly; and
a control circuit receiving and responsive to the output signals of the quadrature axis windings for generating a motor control signal to control commutation of the phase windings.

23. The motor system of claim 22 wherein the stationary assembly includes a plurality of stator teeth defining slots therebetween, said phase windings being sequentially wound on the teeth so that one of the three phase windings is positioned on each tooth and two of the three phase windings are positioned in the each slot, each of said teeth having a centrally situated notch in its face, and wherein the quadrature axis windings are sequentially positioned in the notches of the stator teeth.

24. The motor system of claim 23 wherein the quadrature axis winding corresponding to one of the three phase windings is positioned in the slot in which the other two phase windings are positioned.

25. The motor system of claim 22 wherein the quadrature axis windings comprise a Y-connected circuit.

26. The motor system of claim 22 further comprising an integrator for phase-retarding the output signals of the quadrature axis windings, said integrated output signals being representative of back electromotive force in the respective phase windings, and wherein the control circuit is responsive to the integrated output signals for generating the motor control signal to regulate the motoring current in each of the three phase windings.

27. The motor system of claim 22 wherein the motor control signal generated by the control circuit implements a start-up sequence for starting the motor in the absence of the output signals from the quadrature axis windings at start-up, said start-up sequence defining a sequence of target current levels in the phase windings based on a desired starting torque.
